(19) United States
(12) Patent Application Publication
(10) Pub. No.: US 2001/0024944 A1
(43) Pub. Date: Sep. 27, 2001

(54) Mobile radio transmitter

(75) Inventors: Yasuhiro Shiraki, Tokyo (JP); Shinji Tanabe, Tokyo (JP); Yasuhito Imanishi, Tokyo (JP); Hideaki Shoji, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, TOKYO (JP)

(21) Appl. No.: 09/767,872

(22) Filed: Jan. 24, 2001

(30) Foreign Application Priority Data
Mar. 24, 2000 (JP) 2000-083733

(51) Int. Cl. H04B 1/38

(52) U.S. Cl. 455/90; 455/95; 455/575

(57) ABSTRACT

The invention provides a compact mobile radio transmitter in which deterioration of antenna characteristic due to the influence of human head is decreased. A dielectric material 15 is arranged between a back face of a speaker 12 and a feed point 14 of an antenna 13, and electrical length between the human head and the antenna is increased as compared with the structure without the dielectric material 15.

### BACKGROUND OF THE INVENTION

1. Technical Field

The present invention relates to a mobile radio transmitter for use in mobile communication terminal or semi-fixed terminal such as PHS (personal handyphone system), cellular phone, radio LAN, or the like.

2. Background Art

Hitherto, conventional radio transmitters including cellular phone have been used with a pole antenna extracted from a metal enclosure or with a helical antenna fixed to the metal enclosure of the radio transmitter. Electromagnetic waves radiated from these antennas are greatly distorted in resonance frequency, gain, and directivity due to the influence of human body.

The Japanese Utility Model Registration No. 2601111 proposes to decrease such influence due to the human body by adopting a construction as shown in FIGS. 5 (a), (b), and (c). FIG. 5 (a) is a front view of a conventional mobile radio transmitter, FIG. 5 (b) is a side view of the mobile radio transmitter with its retracted antenna, and FIG. 5(c) is aside view of the mobile radio transmitter with its antenna extracted. In these drawings, reference numeral 1 is a metal enclosure, numeral 2 is a microphone, numeral 3 is an earpiece, numeral 4 is an operation panel, numeral 5 is an antenna, and numeral 6 is an aperture which leads into the inside of the metal enclosure. In FIGS. 5 (a), (b), and (c), the aperture 6 is spaced away from the earpiece 3, and a feed point of the antenna 5, which connects between the antenna 5 and a radio circuit (not shown in the drawings) inside the telephone, is arranged to be spaced away from the human body. FIGS. 5 (a), (b), and (c) also show a construction in which the antenna 5 is obliquely arranged when it is extracted so that the antenna itself is spaced away from the human body. However, position of the aperture 6 is limited in view of the design of the metal enclosure 1, and the feed point of the antenna 5 arranged at the aperture portion is not sufficiently spaced away from the human body. In particular, when the electrical length of the antenna is λ/4, the radiation energy radiated from the antenna becomes maximum. Therefore, in a case where the aperture 6 is near the earpiece 3 as shown in FIGS. 5 (a), (b), and (c), the radiation field is influenced by the human body, especially by the head portion, and consequently, the characteristic of the electromagnetic wave radiated from the antenna 5 is liable to be distorted.

To overcome this problem, in the Japanese Patent Publication (unexamined) No. 340207/1996, the electrical length of the antenna is arranged to be λ/2, thereby reducing the radiation energy radiated from the feed point which is located nearest to the human body, especially to the head portion, in order to decrease influence from the human body, especially from the head portion, and decrease deterioration of the characteristic of the electromagnetic wave radiated from the antenna.

The conventional mobile radio transmitter is constructed as described above, and it is a recent trend that electronic equipments have become lighter and more compact. In particular, portable equipments have been increasingly required to be lighter and more compact. However, in the method for spacing the antenna away from the earpiece to avoid influence from the human body and/or in the method for extracting the antenna with an inclination, mobile radio transmitters tend to be large-sized.

In the mentioned system wherein electrical length of the antenna is arranged to be λ/2, it is certain that the mobile radio transmitter may be desirably prevented from being large-sized on condition that the antenna is retractable. However, this system is difficult to retract the antenna.

In the mobile radio transmitter with its antenna integrated inside the metal enclosure, it is certain that the mobile radio transmitter may be lighter and more compact. But such integrated antenna is influenced by the human body, especially by the head portion, which results in deterioration of the characteristic of the electromagnetic wave radiated from the antenna.

### SUMMARY OF THE INVENTION

The present invention was made to resolve the above-discussed problems and has an object of providing a mobile radio transmitter such as PHS or cellular phone in which the size is small and deterioration of the antenna characteristic due to the human body, especially influence from the head portion, can be decreased.

A mobile radio transmitter according to the first aspect of the invention comprises: a metal enclosure which includes a microphone, an speaker, and an antenna; and a dielectric material arranged between the antenna and an inner wall face of the metal enclosure forming the mobile radio transmitter, the inner wall being on the side where human head comes near; wherein electrical length between the human head and the antenna is increased as compared with the structure without the dielectric material. As a result, it is possible to decrease deterioration of the antenna characteristic due to the influence of human body.

In the invention, the antenna is a pole antenna or a helical antenna. As a result, it is possible to obtain a compact mobile radio transmitter having a superior antenna characteristic.

In the invention, the dielectric material is arranged near a feed point of the antenna. As a result, it is possible to decrease deterioration of the antenna characteristic due to the influence of human body.

In the invention, the dielectric material is arranged between the antenna and a metal disposed inside the metal enclosure of the mobile radio transmitter, and the dielectric material has an area larger than that of the metal. As a result, the distance between the metal and the antenna becomes electrically longer due to the wave length shortage effect of the dielectric material, and it is possible to decrease the size and area of the electromagnetic wave striking upon the metal viewed from the antenna. It is also possible to decrease reradiation from metallic member. It is further possible to decrease deterioration of the antenna characteristic due to the influence of human body.

In the invention, the metal is a speaker. As a result, it is possible to effectively decrease deterioration of the antenna characteristic due to the influence of human body.

In the invention, the antenna is a meander antenna constructed on an antenna base plate(a ground plane of an antenna) arranged inside the metal enclosure of the mobile radio transmitter, and the antenna base plate (a ground plane of an antenna) has the dielectric material on a face side where human head comes near and includes a conductive pattern of the meander antenna formed through a dielectric material between layers on another face. As a result, it is possible to decrease deterioration of the antenna characteristic due to the influence of human head.

### BRIEF DESCRIPTION OF THE DRAWINGS

FIG. 1 is a front view and a side view showing a mobile radio transmitter according to Embodiment 1 of the present invention.

FIG. 2 is a front view and a sectional view showing a mobile radio transmitter according to Embodiment 2 of the invention.

FIG. 3 is an explanatory view showing a condition of using a mobile radio transmitter according to Embodiment 3 of the invention.

FIG. 4 is a side view showing the mobile radio transmitter according to Embodiment 3 of the invention.

FIGS. 5 (a), (b) and (c) are schematic views each showing a conventional mobile radio transmitter.

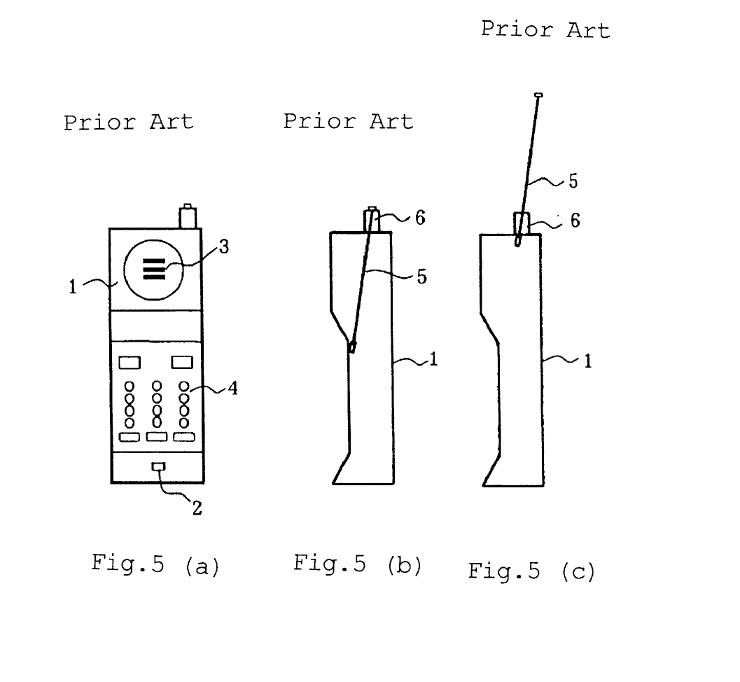

### DESCRIPTION OF THE PREFERRED EMBODIMENTS

Embodiment 1.

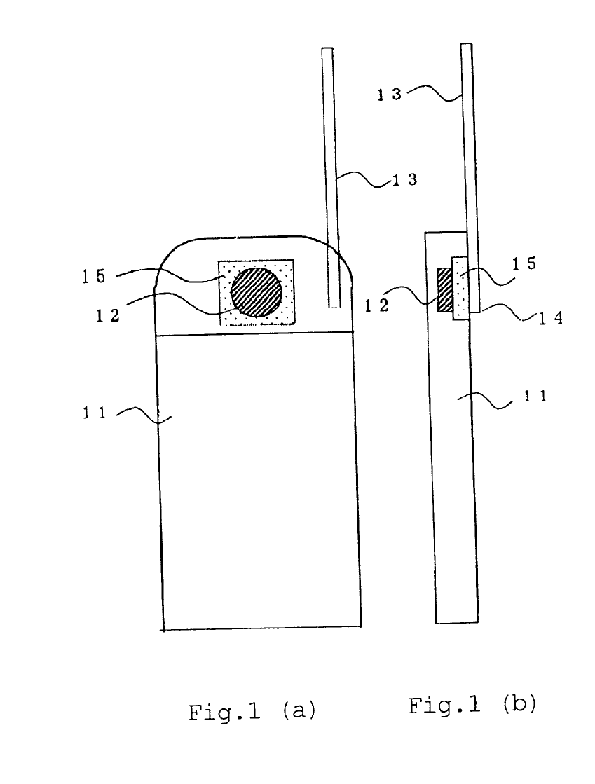

Embodiment 1 of the invention is hereinafter described with reference to the accompanying drawings. FIGS. 1 (a) and (b) are respectively a front view and a side view showing a mobile radio transmitter according to Embodiment 1 of the invention. In FIG. 1, reference numeral 11 is a metal enclosure of the mobile radio transmitter, numeral 12 is a speaker installed inside the metal enclosure 11, numeral 13 is a pole antenna, numeral 14 is a feed point of the antenna 13 which becomes a contact point of a radio circuit (not shown in the drawings) inside the metal enclosure and the antenna 13. Numeral 15 is a dielectric material arranged between the feed point 14 of the antenna 13 and the speaker 12. The dielectric material 15 has an area larger than that of the speaker 12, and is arranged to cover a back face of the speaker 12.

Operation of the mobile radio transmitter of above construction is hereinafter described. When an electromagnetic wave radiated from the antenna 13 is within a region of near electromagnetic field (i.e., a free space region which is approximately 1/(2π) or less of the wave length of the electromagnetic wave radiated from the antenna), dimension of the electromagnetic field reduces in order of square to cube of the distance. In the internal part of the dielectric material, the wave length λε is λ·εᵣ^{-½} ελ:wavelength of the free space, εᵣ:relative permittivity of the dielectric material), and the wave length becomes shorter. Therefore, in the internal part of the dielectric material, electrical length with respect to wavelength becomes longer as compared with the distance in the free space whose thickness is the same as that of the dielectric material. As a result, reduction factor in the dielectric material becomes (εᵣ^{½})² to (ε₂^{½})³ times as much as that in the free space. Thus, wave length shortage effect of the electromagnetic wave becomes larger as the dielectric material is thicker.

In this Embodiment 1, the dielectric material 15 is arranged between the feed point 14 of the antenna 13 and the speaker 12, and covers the back face of the speaker 12. The dielectric material 15 of such construction efficiently reduces the electromagnetic energy radiated from the antenna, and deterioration of the antenna characteristic (change in input impedance, change in radiation pattern, and so on) due to the influence of the human body is decreased. The speaker 12 of the mobile radio transmitter is located nearest to the human body (especially the human head ) among the parts. Therefore, by arranging the dielectric material 15 between the back portion of the speaker 12 and the feed point 14 of the antenna 13, it becomes possible to increase the electrical length between the feed point 14 of the antenna 13 and the human body, as compared with the electrical length in the construction wherein the dielectric material 15 is not arranged. As a result, it is possible to effectively prevent deterioration of the antenna characteristic due to the influence of the human body.

It is certain that the wave length shortage effect is larger when the dielectric material 15 is thicker, but it is preferable to arrange the dielectric material 15 to have a better thickness in consideration of the thickness of the mobile radio transmitter and the antenna characteristic.

It is also preferable that the dielectric material 15 has a small dielectric loss tangent and a large dielectric constant such as silicon, ceramic, liquid crystal polymer, and so on. The ceramic is, for example, Titan Oxide, Titan Oxide Calcium, Titan Oxide Magnesium, and so on.

As described above, in this Embodiment 1, the dielectric material 15 is arranged between the antenna and the inner wall face of the metal enclosure of the mobile radio transmitter, the inner wall face being located on the side where the human head comes near, such as back face of the speaker. The electrical length between the human head and the antenna is increased as compared with that in the construction wherein the dielectric material is not arranged. Therefore, deterioration of the antenna characteristic is decreased even if the electrical length of the antenna is λ/4 and the electromagnetic energy radiated from the feed point is maximum. Thus, it is possible to obtain a compact mobile radio transmitter capable of decreasing deterioration of the antenna.

The way of holding the mobile radio transmitter varies depending upon the user, and the characteristic of the electromagnetic wave radiated from the antenna varies accordingly. In this Embodiment 1, the dielectric material is preliminarily installed in the mobile radio transmitter and the distance from the human body is apparently increased, and therefore the electromagnetic wave is stably radiated from the antenna.

The dielectric material 15 is constructed to cover the back face of the speaker 12 in FIG. 1, however, the portion where the dielectric material 15 is installed is not limited to the back face of the speaker 12. It is also preferable to install the dielectric material 15 between the metal (for example, the display) arranged inside the metal enclosure of the mobile radio transmitter and the vicinity of the feed point 14 of the antenna 13. In such a construction, the dielectric material, having an area larger than that of the metal, can be disposed to cover the metal. By adopting this construction, it is possible to prevent a phenomenon in which electromagnetic wave radiated from the antenna induces the mentioned metal and the electromagnetic wave is reradiated secondarily. As a result, deterioration of the antenna characteristic is decreased.

The metal enclosure 11 is normally composed of a dielectric material. The dielectric material 15 in this embodiment is different from the dielectric material forming the metal enclosure 11, and is arranged between the antenna and the inner wall face of the metal enclosure of the mobile radio transmitter, the inner wall face being on the side where human head comes near.

Though the configuration of the dielectric material 15 is a rectangular parallelepiped in FIG. 1, the same advantage is achieved when the configuration is a circular cylinder or a polygonal cross-section cylinder.

The mentioned advantage is achieved when length of the antenna is m×λ/4 (m: an odd number), and it is also preferable that the length is n×λ/2 (n: a natural number). Deterioration of the electromagnetic wave radiated from the antenna due to the influence of human body is prevented more in the latter length as a matter of course.

Embodiment 2.

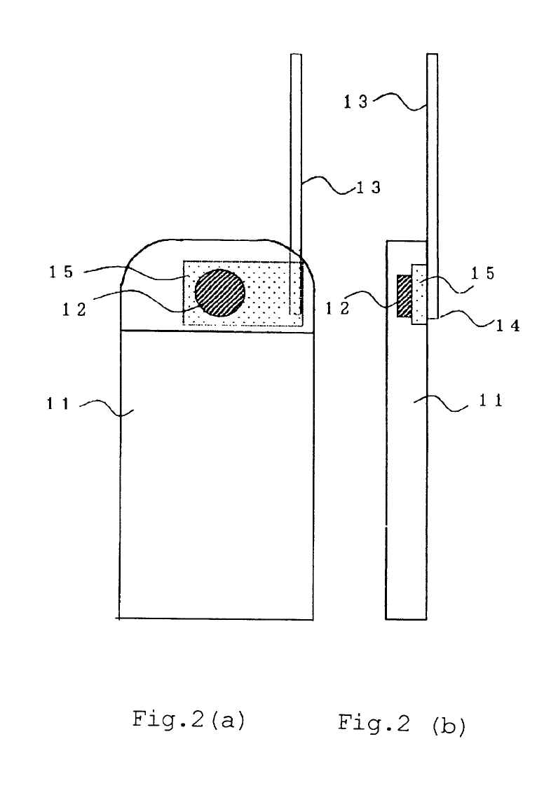

FIGS. 2 (a) and (b) are respectively a front view and a sectional view showing a mobile radio transmitter according to Embodiment 2 of the invention. In this embodiment, the dielectric material 15 is constructed to have an area larger than that of the speaker 12, and cover not only the back face of the speaker 12 but also the vicinity of the feed point 14 of the antenna 13. The dielectric material 15 is arranged between the speaker 12 and the feed point 14 of the antenna 13.

In this Embodiment 2, the dielectric material 15 is securely inserted between the feed point 14 of the antenna 13 and the speaker 12. Therefore, electrical length against the wave length between the human body (especially the human head ) and the feed point of the antenna becomes accurately longer than that in the construction wherein the dielectric material is not inserted. As a result, it is possible to effectively prevent deterioration of the antenna characteristic due to the human body.

The way of holding the mobile radio transmitter varies depending upon the user, and the electromagnetic wave radiated from the antenna varies accordingly. In this Embodiment 2, the dielectric material 15 is preliminarily installed in the mobile radio transmitter and the distance from the human body is apparently increased, and therefore the electromagnetic wave is stably radiated from the antenna.

The dielectric material 15 is constructed to cover not only the back face of the speaker 12 but also the vicinity of the feed point 14 of the antenna 13 in FIG. 2. It is also preferable that the dielectric material 15 is divided into a portion covering the back face of the speaker 12 and a portion covering the vicinity of the feed point 14 of the antenna 13.

It is also preferable that the dielectric material 15 is arranged between the inner wall face of the metal enclosure of the mobile radio transmitter, the inner wall face being on the side where human head comes near, and the feed point 14 of the antenna 13 to cover only the vicinity of the feed point 14 of the antenna 13.

The configuration of the dielectric material 15 is not limited to a rectangular parallelepiped, and the same advantage is achieved when the configuration is a circular cylinder or a polygonal cross-section cylinder.

The mentioned advantage is achieved when length of the antenna is m×λ/4 (m: an odd number), and it is also preferable that the length is n×λ/2 (n: a natural number). Deterioration of the electromagnetic wave radiated from the antenna due to the human body is prevented more in the latter length as a matter of course.

Embodiment 3.

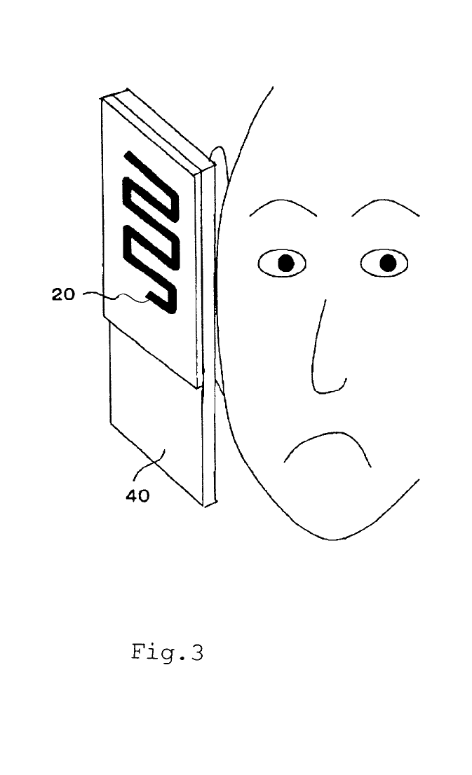

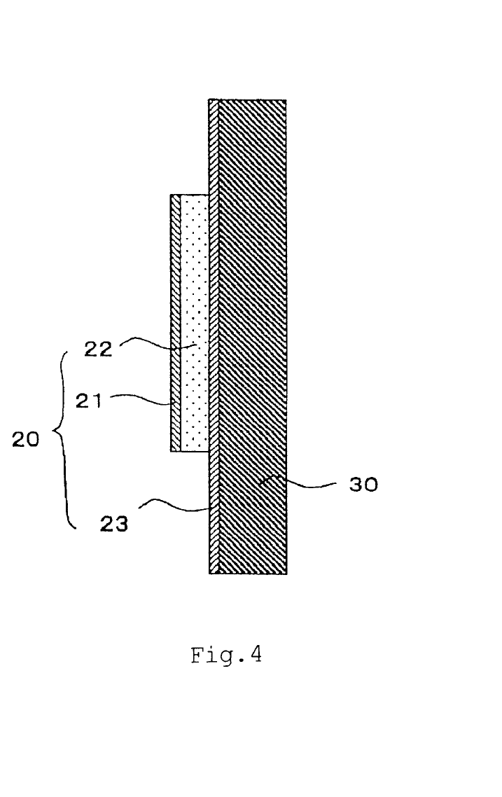

FIG. 3 is an explanatory view showing a condition of using a mobile radio transmitter according to Embodiment 3, and FIG. 4 is a sectional view showing the mobile radio transmitter according to Embodiment 3. Embodiment 3 relates to a mobile radio transmitter with its antenna integrated inside the metal enclosure of the mobile radio transmitter.

In FIGS. 3 and 4, numeral 20 is a meander antenna composed of a meandering conductive pattern, and is installed inside the metal enclosure of a mobile radio transmitter. Numeral 21 is a conductive portion of the meander forming the meander antenna 20, numeral 22 is a dielectric material between layers forming the meander antenna 20, and numeral 23 is an antenna base forming the meander antenna 20. Numeral 30 is a dielectric material of d in thickness mounted on the mentioned meander antenna 20, and a highly dielectric material made of, for example, silicon, ceramic (Titan Oxide, Titan Oxide Calcium, Titan Oxide Magnesium, and so on), liquid crystal polymer, and so on, is used. Numeral 40 is a metal enclosure of the mobile radio transmitter.

In this Embodiment 3, as shown in FIG. 3, the mentioned dielectric material 30 is arranged in the metal enclosure to face the human head side, and the dielectric material 30 is arranged between the meander antenna 20 and the inner wall face of the metal enclosure of the mobile radio transmitter, the inner wall face being on the side where the human head comes near. As a result, because of the dielectric constant of the dielectric material 30, the electrical length with respect to the wave length between the meander antenna 20 and the human head is εᵣ^{½} times as large as the actual distance d and becomes εᵣ^{½}·d. It is therefore possible to decrease deterioration (change in input impedance, change in radiation pattern, and so on) of the antenna characteristic due to influence of the human head.

Though this Embodiment 3 shows the meander antenna composed of the meandering conductive pattern, it is also preferable that the antenna is formed into a spiral conductive pattern or another conductive pattern.

Though this Embodiment 3 shows the mobile radio transmitter in which the meander antenna 20 is arranged on the dielectric material 30, the dielectric material 30 can be installed at any position between the meander antenna and the inner wall face of the metal enclosure of the mobile radio transmitter, the inner wall face being on the side where the human head comes near. It is preferable to arrange the dielectric material 30 to cover the back face of the speaker in the same manner as in Embodiment 1. It is also preferable to arrange the dielectric material 30 to cover the feed point of the antenna in the same manner as in Embodiment 2.

It is to be understood that the invention is not limited to the foregoing embodiments and various changes and modifications may be made without departing from the spirit and scope of the invention.

What is claimed is:

1. A mobile radio transmitter comprising:
a metal enclosure which includes a microphone, a speaker, and an antenna; and
a dielectric material which is arranged between said antenna and an inner wall face of said metal enclosure forming the mobile radio transmitter, said inner wall being on the side where human head comes near,
wherein electrical length between the human head and the antenna is increased as compared with a construction in which said dielectric material is not arranged.

2. The mobile radio transmitter according to claim 1, wherein the antenna is a pole antenna or a helical antenna.

3. The mobile radio transmitter according to claim 2, wherein the dielectric material is arranged near a feed point of the antenna.

4. The mobile radio transmitter according to claim 1, wherein the dielectric material is arranged between the antenna and a metal disposed inside the metal enclosure of the mobile radio transmitter, and the dielectric material has an area larger than that of the metal.

5. The mobile radio transmitter according to claim 4, wherein the metal is said speaker.

6. The mobile radio transmitter according to claim 1, wherein the antenna is a meander antenna installed on an antenna base plate arranged inside the metal enclosure of the mobile radio transmitter, and the antenna base plate has the dielectric material on a face side where human head comes near and includes a conductive pattern of the meander antenna formed through a dielectric material between layers on another face.
